(19) United States
(12) Patent Application Publication
(10) Pub. No.: US 2019/0325522 A1
(43) Pub. Date: Oct. 24, 2019

(54) BLOCKCHAIN DRIVEN UNIFIED MULTI-PARTY SYSTEM AND METHOD FOR MONITORED TRANSACTIONS OF URBAN ASSETS

(71) Applicant: Conduent Business Services, LLC, Dallas, TX (US)

(72) Inventors: Krupa Vrajlal Bathia, Gujarat (IN); Aditya Hegde, Karnataka (IN); Krishnaprasad Narayanan, Chennai (IN); Ashwini Sanjay Marathe, Nagpur (IN); Tridib Mukherjee, Bangalore (IN)

(21) Appl. No.: 15/955,781

(22) Filed: Apr. 18, 2018

(51) Int. Cl. G06Q 40/06; H04L 9/06; G06K 9/00

(52) U.S. Cl. CPC G06Q 40/06; H04L 67/12; G06K 9/00624; H04L 9/0637

(57) ABSTRACT

A blockchain-based system and method for managing urban assets such as parking spaces with a ledger data structure. In an example embodiment, a blockchain-based platform can be configured, which unifies a plurality of stakeholders with respect to one or more digital/physical assets. The blockchain-based platform is configured to provide the stakeholders with weighted control and ownership of data regarding the asset (or assets). The blockchain-based platform is also configured to enable tracking of the true state of the asset by maintaining a single version of truth, thereby avoiding disputes with respect to the asset while facilitating on-demand sharing of the asset.

### TECHNICAL FIELD

Embodiments are generally related to the fields of distributed ledgers and asset management. Embodiments also relate to blockchain-based platforms and networks. Embodiments also relate to multi-party systems and methods for monitoring transactions of urban assets such as parking resources.

### BACKGROUND

With the emergence of intelligent infrastructure and applications, citizens expect urban resources to be connected, informative, and shared using responsive and robust technologies. Further, consumers expect that businesses serve them with the least turnaround time and that such services be free from disputes. Having such technologies not only renders cities “smart,” but also enriches peoples' lives by creating a safer and sustainable environment.

Different domains suffer from different problems. For example, in supply chain management, businesses may experience a difficult time resolving disputes. In the mortgage domain, the government may face a great deal of problems in tracking the true owner of a real estate asset. In urban environments, parking planning and management is a difficult challenge, particular in the context of the “smart” city goal. One of the key challenges in building so-called smart cities is to efficiently manage parking services.

A study reveals that in urban environments on average 31% of land is utilized for parking. In fact, this is a significant problem in large cities such as Los Angeles (81%) and Melbourne (76%). High-density parking requirements restrain urban redevelopment. This leads to problems such as traffic congestion, fuel waste in search of parking spaces, unauthorized parking, etc. Thus, it is of paramount importance to deploy smart parking solutions deployed in urban environments.

Cities such as Los Angeles and San Francisco have deployed some parking solutions such as, for example, SFpark and LA Express park, to cater to their respective parking needs. A recent work—CloudParc—has applied computer vision and machine learning tools for identifying available spaces and offering real time data for monitoring and enforcing parking rules. Another existing system in this domain focuses on solutions to problems involving data collection from sensors (e.g., IoT (Internet of Things), crowdsourcing, GaParking, etc.), system deployment, and service dissemination.

Most of the existing solutions work in this area, however, does not involve multiple stakeholders of the ecosystem. That is, the disjoint nature of these systems can create multiple sources of truth. As most of these systems are highly provider centric, the problem becomes further magnified in terms of lack of trust. Further, it is highly challenging to enforce compliance and standardization on such fragmented systems.

The current fragmented nature of the parking domain, particularly in large urban environments, presents a number of problems. Currently, there are typically various parking lots in a city or other urban environment, some of which may be publicly owned and some of which are privately owned. Each parking lot owner, for example, typically provides information about the count of empty parking slots in their respective parking lots. Since the information is available in siloes, if a user wants to find a free parking space, he or she will need to individually check with each service providers (e.g., parking lot owners).

Such fragmented information with different rates for each parking slot makes it difficult for the user to choose an optimal (e.g., cost optimized, distance optimized) parking space. Also, this haphazard process of finding free parking spaces leads to increased traffic, unnecessary fuel consumption, and wastes time. Moreover, each service provider and the user must rely on a trusted third party (e.g., a Bank, credit card company, or other financial institution) to facilitate payment.

Currently in every trade activity, the government/enforcing agency has set some rules that have to be followed and/or some taxes that have to be paid. To do this, the enforcing body (i.e., the “enforcer”) must monitor and interact with each of service provider individually. Additionally, the service provider and the enforcing agency, individually, maintain a record of the taxes paid and the violations present. This leaves a margin for disputes later. Some of the other problems that the publicly owned parking lots face involve compliance (users not paying for using the parking space) and overpayment (users paying extra as they cannot determine the time for which they are going to park).

The conventional solutions mentioned above (e.g., SFpark, LA Express park, and CloudParc) involve a single entity owning data (e.g., transactions, prices, tax rates, etc.) in spite of the fact that the data impacts multiple parties. Segments of data are maintained by different entities such as, for example, a law-enforcing agency (e.g., tax rates), providers (e.g., taxes paid, price rates, etc.) and so on, which create multiple versions of the same data with possibilities of inconsistencies and disputes, not to mention privacy and security issues. Such data can be modified by the data owning entity without the consent of all the stakeholders. In other words, the above solutions are not completely transparent and do not provide a platform to arrive at a mutual consensus.

A solution to these problems, as will be discussed in greater detail herein, involves the implementation of a new platform that addresses the above limitations. In such a new platform, the stakeholders (e.g., providers, consumers, enforcing agencies, etc.) have a weighted ownership and control (i.e., configurable) over the data. As will be discussed herein, the disclosed solution enables standardized policy enforcement across providers. Finally, the disclosed platform offers a single source of true data, thereby avoiding any future disputes, which in turn leads to a reduced overall turnaround time.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a method and system for monitoring transactions of urban assets.

It is another aspect of the disclosed embodiments to provide for a blockchain-driven unified multi-party system for monitored transactions of urban assets.

It is a further aspect of the disclosed embodiments to provide for a blockchain based platform in which stakeholders have a weighted ownership and control over data.

It is also an aspect of the disclosed embodiments to provide a blockchain based method and system that enables standardized policy enforcement across providers.

It is a further aspect of the disclosed embodiments to provide for a blockchain based method and system that offer a single source of true data.

The aforementioned aspects and other objectives and advantages can now be achieved as described herein. A blockchain-based system and method for managing urban assets such as parking spaces is disclosed. In an example embodiment, a blockchain-based platform can be configured, which unifies a plurality of stakeholders with respect to one or more digital/physical assets. The blockchain-based platform is configured to provide the stakeholders with weighted control and ownership of data regarding the asset (or assets). The blockchain-based platform is also configured to enable tracking of the true state of the asset by maintaining a single version of truth, thereby avoiding disputes with respect to the asset while facilitating on-demand sharing of the asset.

The blockchain-based platform includes an electronic ledger (i.e., a distributed ledger) that tracks a plurality of events associated with the asset. The asset preferably constitutes shareable asset. In addition, one or more IoT (Internet of Things) devices can be utilized to monitor the identity of the asset. In some example embodiments, such an IoT device may be, for example, an ALPR (Automated License Plate Recognition) sensor and/or a digital camera with image recognition features.

The disclosed embodiments generally describe a blockchain-based unified platform managing urban assets such as parking spaces. The disclosed approach creates a system that unifies all the stakeholders (e.g., consumers, enforcers, and service providers, etc.) of an ecosystem (e.g., a parking system) through blockchain enabling them to have weighted control and ownership of the data. This approach also enables tracking of the true state of the digital/physical assets by maintaining a single version of truth, thus avoiding disputes and facilitating the on-demand sharing of assets. A blockchain-based ledger can be utilized to track and manage the arrival and departure of, for example, a specific vehicle in a parking spot asset and arranging the transfer of money from the consumer to the provider (i.e., payment for a parking spot). The identity of the vehicle can be monitored through ALPR detection systems and devices.

One advantage of the disclosed embodiments is that the underlying blockchain architecture allows heterogeneous types of urban assets to be handled efficiently while enjoying all the advantages of blockchain such as maintaining a single version of truth across different parties. With the emergence of blockchain as a disruptive technology for managing digital/physical assets.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a conventional parking management system;

FIG. 2 illustrates a schematic diagram depicting an example of a blockchain network;

FIGS. 3A-3B illustrate a schematic diagram of a system for managing assets, in accordance with an example embodiment;

FIG. 4 illustrates a flow diagram depicting logical operational steps of a method for managing an asset dispute, in accordance with an example embodiment;

FIG. 5 illustrates an example data structure that can save the details of an active consumer using an asset, in accordance with an example embodiment;

FIG. 6 illustrates an example of a provider-consumer smart contract that can be implemented in accordance with an example embodiment;

FIG. 7 illustrates a flow diagram depicting logical operational steps of a method for automated free parking space identification and assisted navigation, in accordance with an example embodiment;

FIG. 8 illustrates a flow diagram depicting logical operational steps of a method for traffic violation detection and fine imposition, in accordance with an example embodiment;

FIG. 9 illustrates a schematic diagram of a system that includes interactions among stakeholders and a blockchain network, in accordance with an example embodiment;

FIG. 10 illustrates a schematic view of a computer system/apparatus, in accordance with an example embodiment; and

FIG. 11 illustrates a schematic view of a software system including a module, an operating system, and a user interface, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

Unless defined otherwise, all technical and scientific terms used herein have the same meanings as commonly understood by one of ordinary skill in the art. As used in this document, the term “comprising” means “including, but not limited to.”

A “computing device” or “electronic device” or “data processing system” refers to a device or system that includes a processor and non-transitory, computer-readable memory. The memory may contain programming instructions that, when executed by the processor, cause the computing device to perform one or more operations according to the programming instructions. As used in this description, a “computing device” or “electronic device” may be a single device or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players, and the like.

The terms “computer program medium” and “computer usable medium” and “computer readable medium” are used to generally refer to media such as removable storage drive and a hard disk installed in hard disk drive. These computer program products provide software to computer system.

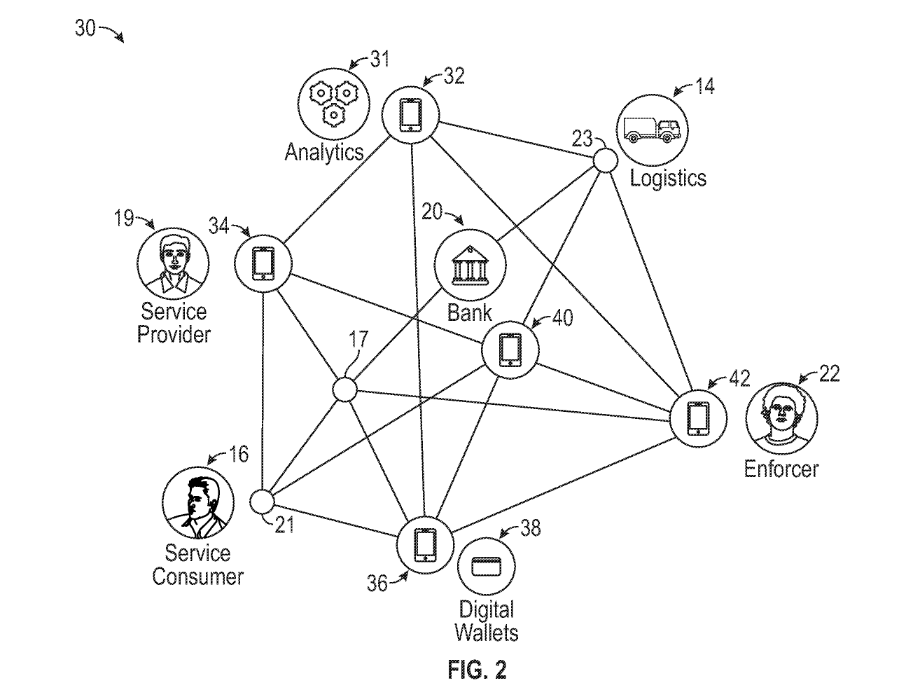

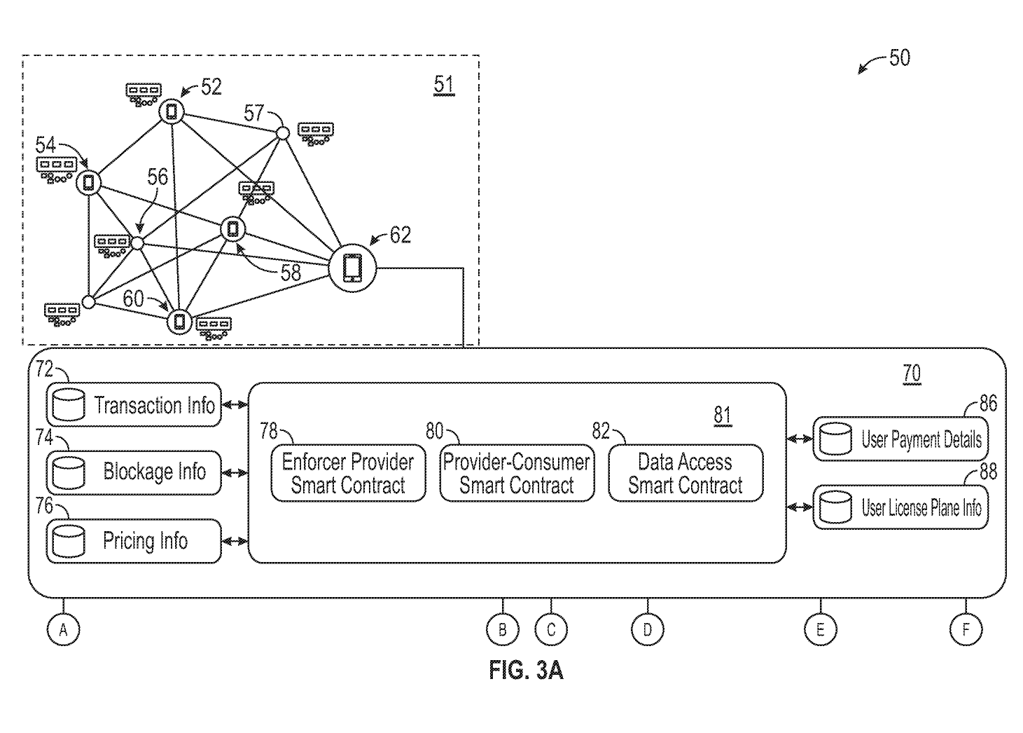

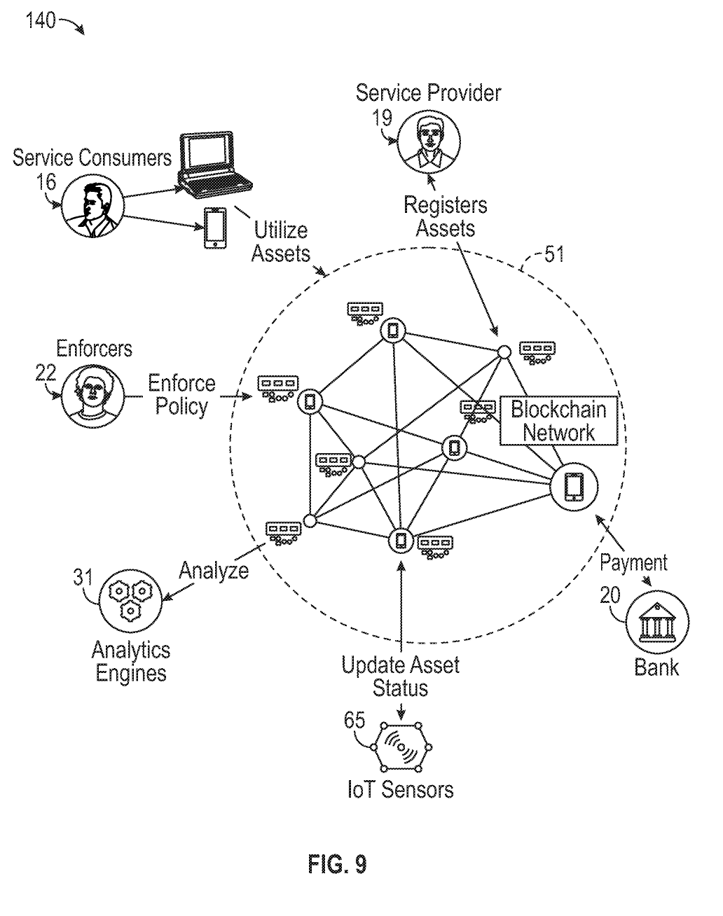

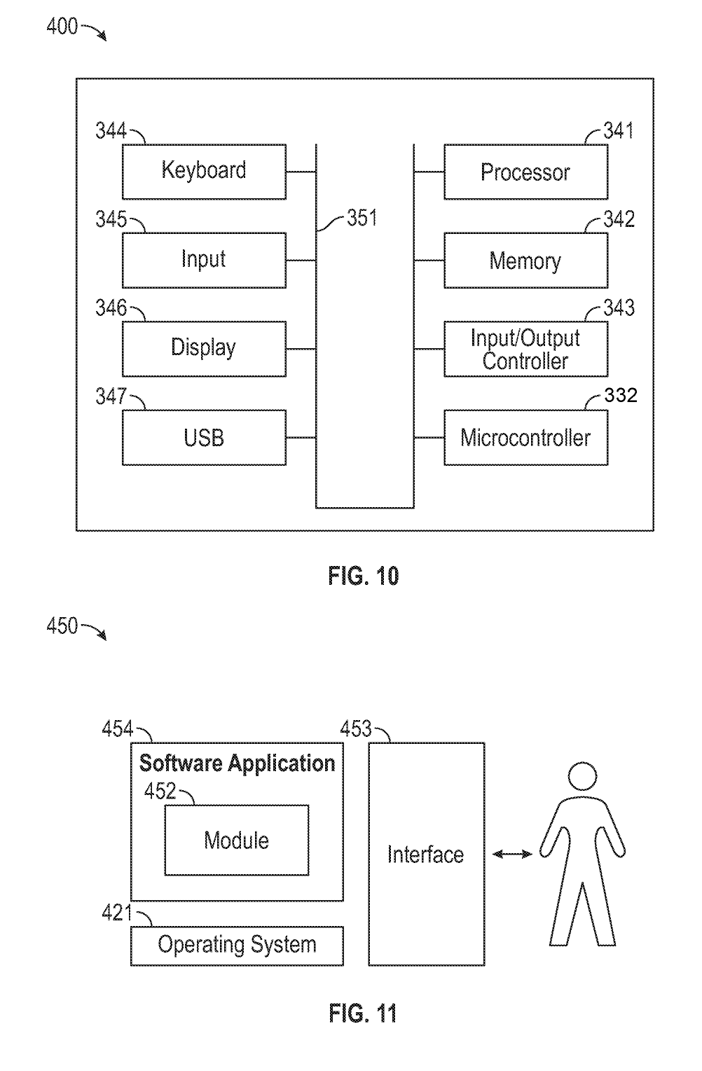

Various elements of an example of a computing device or processor are described below in reference to FIGS. 10-11. The various servers such as, for example, servers 32, 34, 36, 40 and 42 shown in FIG. 2 and server 62 shown in FIG. 3A are examples of computing devices or data processing systems that can be implemented in accordance with one or more embodiments.

In this document, the terms “communication” and “electronic communication” refer to the ability to transmit data via one or more signals between two or more electronic devices, whether through a wired or wireless network, and whether directly or indirectly via one or more intermediary devices.

In this document, the term “Blockchain” or “blockchain” refers to a continuously growing list of records, known as blocks, which are linked and secured using cryptography. Each block typically contains a cryptographic hash of the previous block, a timestamp, and transaction data. By design, a blockchain is inherently resistant to modification of the data. It is an open distributed ledger that can record transactions between two parties efficiently and in a verifiable and permanent manner. A peer-to-peer network collectively adhering to a protocol for validating new blocks, which enables the blockchain to be utilized as a distributed ledger, can manage a blockchain. Once recorded, the data in any given block cannot be altered retroactively without the alteration of all subsequent blocks, which requires collusion of the network majority. Blockchains are thus secure by design and are an example of a distributed computing system having a high Byzantine fault tolerance. Decentralized consensus can therefore be achieved with a blockchain.

Blockchain is an electronic replicated ledger in which transactions are recorded. A blockchain database can be implemented by software. Such software can be referred to as blockchain software that is executed by each computer client (e.g., referred to as a node or a miner). Each computer client can participate in the particular overall system for which the data stored in the blockchain is being used. Generally, the software running on each node maintains a copy/replica of the blockchain data/database. The combination of the blockchain database and the software that maintains the blockchain database can be collectively referred to simply as a blockchain or a replicated blockchain. The data stored in a blockchain is typically coalesced, collected, or grouped together, such as on a quantitative and/or periodic basis, into blocks where each block is coupled or linked, such as in a cryptographic manner, with a prior block forming a chain of blocks which may continue to grow as new data is added.

Note that each of the replicated blockchains can also communicate over the internal network that is part of an enterprise/organization and/or over the Internet. The term Internet as used herein refers generally to a public network, which may not be the case all the times. It will be appreciated that the term network, in addition to referring to the communications medium by which replicated blockchains communicate, may also be used to refer to the collection of blockchain clients which are implementing a particular system using a blockchain database for data storage and other functions, which may also be referred to as a blockchain network.

The blockchain software further implements particular rules for allowing/validating modifications, e.g., addition of new transactions, to the blockchain database by the operator of the particular client as well as for validating and implementing modifications to the blockchain database received from other clients. These rules are generally defined by the type of system the blockchain network is being used to implement, and are coded into the software. In order to change these rules, the software must be updated.

As will be discussed in greater detail herein, example embodiments can be implemented, which are based on blockchain technology. The disclosed embodiments aim to catalyze greater collaboration between different stakeholders of an ecosystem in trading physical/digital assets stewarded by an enforcing agency (e.g., nonprofit/government organization). However, one can alternatively think of a centralized system managed by the enforcing agency, but this situation would render the agency the sole owner of the transaction data. This approach is non-transparent and provides a room for the enforcing agency in tampering with the data. Therefore, devising a solution where the enforcing agency is neither the sole owner nor has a majority stake in the ownership of transaction data is extremely important. Note that as utilized herein the term transaction can refer to transactions performed on or with respect to the asset.

Creating a solution around blockchain for unified multi-party asset trading in Urban Infrastructure (e.g., efficient utilization of parking spaces) is a non-trivial task. First and foremost, it is important to re-imagine and re-model the processes in an unconventional manner so as to maximize the value of trust, transparency, timeliness, and immutability properties of blockchain. Secondly, it is important to consider the dynamics of domain parameters (e.g., status of parking spaces, ownership of land, etc.) while modeling the process.

Herein, a parking solution using Blockchain is proposed, but it should be appreciated the disclosed embodiments can be extended to different ecosystems (i.e., other than the parking domain). The disclosed solution on the blockchain platform unifies all the stakeholders of an ecosystem or domain. Further, its immutable feature helps maintain a single version of truth. This ensures trust among the parties. Since every stakeholder is part of the platform, stewardship can be easily achieved. Different parties can leverage smart contracts (i.e., the only way to access data stored on blockchain) for trading the assets with terms of trade, state of the asset, etc. For the parking use case, the providers, the consumers, and the enforcers can transact securely and seamlessly over the blockchain resulting in effective utilization of parking services and cost savings for the stakeholders.

Traditionally, smart solutions for urban infrastructure work in siloes resulting in an incomplete/fragmented view of the overall system to its stakeholders. This results in ineffective partnership, multiple versions of truth, and underutilization of assets. Such fragmented systems also hamper efficient stewardship. The disclosed framework leverages blockchain to enable a unified platform for managing urban infrastructure. In this regard, the disclosed embodiments can tackle the non-trivial problems of modeling and re-imagining processes in the domain while considering the dynamics of domain parameters.

The immutability property of the blockchain assists in tracking the true state of digital/physical assets, hence maintaining a single version of truth. This helps in filling the gap of trust, which is either non-existent or crafted using third party (e.g., Bank) in existing/conventional solutions. As a result, the asset trading between the stakeholders of the ecosystem can occur seamlessly with utmost trust because of shared, platform enabled decision-making, and data ownership. The policy enforcers (e.g., a government body, a non-profit organization such as IETF, ICANN, etc.) can efficiently steward the entire ecosystem of transactions.

In order to dearly enunciate the disclosed concept, the embodiments discussed herein relate to parking as a use case. As indicated previously, however, the concept and hence the disclosed invention can be extended to different urban infrastructures. In the disclosed example embodiments, a set of users, private agencies, or government agencies as parking providers can be provided along with a set of users as parking consumers, a government body as policy enforcer, and a bank for payment. Using such an example framework, the providers should be able to securely and seamlessly provide parking services and the consumers should be able to utilize the service and securely pay the service charges without breaking any policies enforced by the government. This is enabled by blockchain technology working as the backbone of the platform. Using this unique approach, one can build a “sharing economy” stewarded by a policy enforcing body.

Key novelties of the disclosed embodiments include, for example, a system and method that unify all stakeholders of an ecosystem through blockchain, thereby enabling such stakeholders to possess weighted control and ownership of data. In addition, the disclosed embodiments provided for a system and method that enable tracking of the true state of digital/physical assets by maintaining a single version of truth, thereby avoiding disputes, providing on-demand sharing of assets, and so on. This approach further reduces the cost and improves the availability/utilization of assets. Finally, the disclosed embodiments provide for a method and system for facilitating enhanced stewardship of multiparty transactions.

It should be appreciated that blockchain technology is rapidly maturing and has attracted the attention of industries spread across diverse domain and sectors. Some of the notable domains using blockchain are financial services, supply chain management, health care, government sector, digital right ownership, and notary services. The disclosed embodiments focus on the domain of Urban Informatics and apply the technology of blockchain to the use case of parking as an example.

While blockchain is being widely adopted by banking and other financial and non-financial sectors, the disclosed embodiments and solutions are the first of their kind that cater to the domain of Urban Informatics. As discussed previously, many solutions have been proposed, which focus on the development and evolution of “smart” parking. It is important to note, however, that none of these solutions have used blockchain as the underlying technology. SFpark and LA Express Park discussed previously are examples of conventional solutions that were primarily designed to cater to big cities such as San Francisco and Los Angeles. CloudParc, discussed previously, applies computer vision and machine learning tools for identifying available spaces and further offer real time data for monitoring and enforcing parking rules.

In addition to these fragmented systems, the existing works offer solution to problems that involve data collection from sensors (e.g., IoT, crowd sourcing, GaParking), system deployment service dissemination. As the name describes, the former focuses on using parking meter and different sensing techniques such as crowd sourcing, stationary and mobile sensors, and cities infrastructure to efficiently gather information. Conventional system deployments cover software solutions and the analytics applied (e.g., forecasting the parking occupancy rate, parking reservation) around the collected data. Typical solutions are designed for large-scale deployments and contain features such as E-Parking, reservation, guidance and monitoring information for administration, and users.

Lastly, service dissemination deals with the investigation of gathered data and its correlation with social features. Notable studies in this area include approaches for enabling dynamic pricing and understanding the driver's parking behavior.

The major drawback of such traditional parking solutions is that they are designed to work in siloes resulting in a partial or fragmented view of the overall system to its stakeholders. This causes ineffective partnership, multiple versions of truth, and underutilization of assets. Such fragmented systems also hamper efficient stewardship. These limitations can be overcome by utilizing blockchain as the underlying technology. The disclosed embodiments thus offer a unique solution in the domain of Urban Informatics.

In a smart city setup, citizens expect urban resources to be connected, informative, and shared using responsive and robust technologies. This creates a safe and sustainable ecosystem. One of the major challenges faced in this domain is the efficient management of parking spaces and to provide a holistic view of the system to the stakeholders. There are various smart parking solutions in the market. But they all suffer with the problem of siloed operation and fragmented view of the system to the stakeholders.

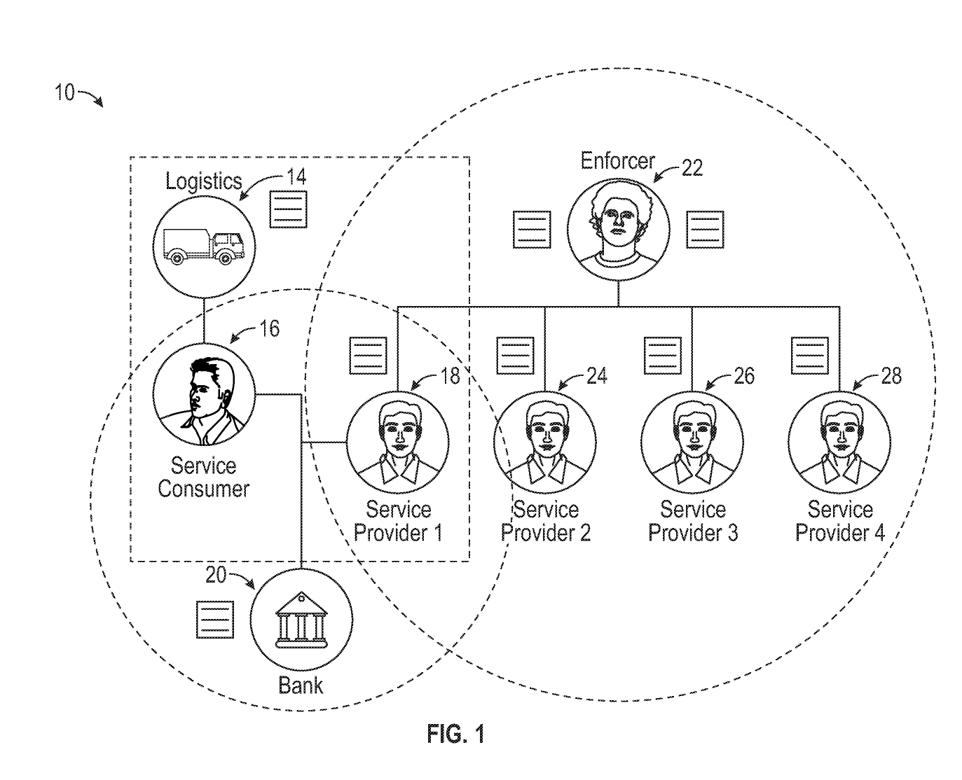

FIG. 1 illustrates a schematic diagram of a conventional parking management system 10. The system 10 shown in FIG. 1 generally includes one or more service providers 18, 24, 26, and 28 with respect to an enforcer 22. A bank 20 may communicate with a service consumer 16 and the service provider 18. The service consumer 16 and the service provider 18 can further communicate or interact with a logistics operation 14.

FIG. 1 demonstrates the current state of many stakeholders in the ecosystem. There are various parking lots in the city, some publicly owned and some privately owned. Each parking lot owner will have information about the count of empty parking slots in their respective parking lots. The information is available in fragments.

Thus, if a user wants to find a free parking space, he or she will have to individually check with each of the service providers 18, 24, 26, and 28 (e.g., parking lot owners). This fragmented information with different rates of each parking slot makes it difficult for the user (e.g., service consumer 16) to choose an optimal (e.g., cost optimized, distance optimized) parking space. Also, this process of finding free parking spaces leads to increased traffic in the city, unnecessary fuel consumption, and wastes time. Moreover, the service provider 18 and the user must rely on a trusted third party such as, for example, the bank 20 shown in FIG. 1 to facilitate payment.

As discussed previously in every trade activity, the government/enforcing agency must set some rules that have to be followed and/or some taxes that have to be paid. To accomplish this, the enforcing body—the enforcer 22—has to monitor and interact with each of the service providers 18, 24, 26, and/or 28 individually. Additionally, the service provider 18 and the enforcing agency 22, individually, maintain a record of the taxes paid and the violations present. This leaves a margin for disputes later.

To overcome these problems, the disclosed parking solution is implemented using blockchain as the underlying technology. Some of the other problems that the publicly owned parking lots face involve compliance (e.g., users not paying for using the parking space) and overpayment (e.g., users paying extra as they cannot determine the time for which they are going to park), which can be solved using IoT and Blockchain combined. The disclosed embodiments are robust and powerful enough to cater to both.

FIG. 2 illustrates a schematic diagram depicting an example of a blockchain network 30 (i.e., a Blockchain-based system), which can be implemented in accordance with an example embodiment. Blockchain is a trusted distributed network, which provides a secure mechanism to share data and record transactions in a conditional, transparent, and immutable fashion. The biggest motivation for using this technology is that there is no reliance on a trusted third party to ensure secure transactions. Within the Blockchain network, all the transactions are validated by a consensus of peers participating in the network. The transactions are non-repudiable, transparent to all the stakeholders, and cryptographically secure.

Blockchain is the only platform, which facilitates controllable read and write permissions to stakeholders across organizations. Blockchain also has the capability to automate cross-organizational/multi-stakeholder actions on fulfillment of certain conditions. This can be achieved through the use of “smart” contracts, which control data visibility and allow only the relevant stakeholders to access data. Such smart contracts provide rules for monitoring parameters of importance and then taking necessary actions. Smart contracts are the only way to access and modify the data stored on the blockchain network. All data accessed via smart contracts is immutably stored on the blockchain network in the form of transactions. The disclosed blockchain platform includes an improved ledger data structure (the blockchain) for use in unifying all stakeholders and implementing a unified multi-party system and/or method for monitoring transactions of urban assets (as discussed in greater detail herein). This represents an actual improvement in computer technology.

In the example shown in FIG. 2, a number of stakeholders such as service provider 19, service consumer 16, and an enforcer 22 are shown. Other features include an analytics engine 31 associated with or running on a server 32, a digital wallet 38 running on or associated with a server 36. Additional servers include a server 40 associated with the bank 20 and an enforcer 22 associated with a server 42. Various nodes such as nodes 17, 21, and 23 are also shown in FIG. 2. Each such node represents the deployment of components. A node such as node 17, 21, 23, and so on, may refer to a physical server, virtual machine, or container.

Note that the term digital wallet as utilized in this document generally refers to an electronic device (e.g., including hardware and software) that allows an individual to make electronic transactions. This can include purchasing items on-line with a computer or using a smartphone to purchase something at a store. An individual's bank account can also be linked to the digital wallet. They might also have their driver's license, health card, loyalty card(s), and other ID documents stored on the phone. The credentials can be passed to a merchant's terminal wirelessly via, for example, NFC (Near Field Communications). Increasingly, digital wallets are being made not just for basic financial transactions, but to also authenticate the holder's credentials. For example, a digital wallet could verify the age of the buyer to the store when purchasing goods/items where the buyer's age may prevent the buyer from purchasing particular types of goods/items. A cryptocurrency wallet is an example of a digital wallet where private keys are stored for cryptocurrencies such Bitcoin, Etherium, and so on.

The stakeholders form a fully connected network and own nodes, which are responsible for transaction validation. They are a gateway for stakeholders to access the relevant data. Each node holds the same copies of smart contract, transaction database, and the database of parameters of importance. Blockchain itself takes care of maintaining consistency amongst these databases, thereby resulting in a single version of truth. Examples of such nodes include nodes 17, 21, and 23 shown in FIG. 2. The service consumer 16 thus is associated with or can access node 21 which in turn can communicate with node 17, server 36, server 34, server 40, and so on. The logistics node 23 is associated with a logistics operation 14.

FIG. 3A illustrates a schematic diagram of a system 50 for managing assets, in accordance with an example embodiment. The system 50 includes a blockchain network 51 composed of various servers such as servers 52, 54, 58, 60, and 62, and various nodes such as nodes 56, 57, and so on. The blockchain network 51 (which can also be referred to simply as the Blockchain) communicates with a layer 70 composed of various databases such as, for example, a transaction information database 72, a blockchain information database 74, a pricing information database 76, a database 86 that maintains user payment information, and a database 88 that includes user license plate information (e.g., vehicle license plate data).

A group of analytical engines 90, 92 and 94, as shown in FIG. 3B, can communicate with the layer 70. The analytical engines 90, 92 also communicate with a service provider 103 that includes both a public feature 96 and a private feature 98. The analytical engine 94 further can communicate with an enforcing agency 100 (e.g., government, etc.). An empty parking detector and router component 102 also communicates with the layer 70 and one or more service consumers 106 and 108 that in turn interact or communicate with an input device 104 (e.g., an IoT device). The input device 104 further communicates with the layer 70. A bank 110 or other financial institution may communicate with the layer 70.

One or more “smart” contracts such as an enforcer-provider smart contract 78, a provider-consumer smart contract 80, and a data access smart contract 82 can facilitate interactions among the various databases 72, 74, 76, 86, and/or 88 within the layer 70. Note that the term “smart contract” as utilized in this document refers to a computer protocol intended to digitally facilitate, verify, or enforce the negotiation or performance of a contract. A “smart” contract allows for the performance of credible transactions without third parties. These transactions are preferably trackable and irreversible.

FIGS. 3A and 3B thus provides detailed views of an example parking solution embodiment (implemented using Blockchain) with all the interacting components. The architecture diagram shown in FIGS. 3A and 3B is specific to the parking use case, but can be extended for any other asset-sharing scenario. The components of the architecture are explained below.

Service providers as the name suggests are organizations that provide any service. These can be either private service providers (e.g., commercial organizations or individual users) or public service providers (e.g., government). In the disclosed parking use case scenario, they are parties that own the parking space. Thus, the service provider 103 shown in FIG. 3B is an example of a service provider.

Service consumers can be anyone who uses services provided. Service consumers can also be organizations or individual users, for example, people who want to park in the disclosed use case. Thus, service consumers 106 and 108 are examples of service consumers. Payment/institutions (e.g., banks) situated as nodes in system 50 can facilitate automatic payments from, for example, the service consumers 106 and 108 to one or more of the service providers, such as service provider 103, upon completion of services. Bank 110 is an example of a payment institution and/or system. The enforcing agency 100 is the enforcing agency or organization that monitors and takes necessary action regarding transactions that occur between the service providers and service consumers per the required law and rules and regulations.

Data capturing, processing and analyzing systems, such as, for example, the analytical engines 90, 92, and 94 can be based on the service that is provided. That is, these systems can capture real world data and provide the blockchain network 51 with relevant information. Such data capturing, processing, and analyzing systems can also provide triggers to the blockchain network 51 to perform certain actions. Some of these systems may read the data stored on the blockchain network 51 via, for example, “smart” contracts (e.g., contracts 78, 80, and/or 82) and provide useful insights to service providers/enforcers/consumers. The data capturing systems in our use case scenario will auto-detect the presence of a car and read its license plate number. The analyzing systems will give insights about occupancy of any parking lot at any given point and help in performing dynamic pricing.

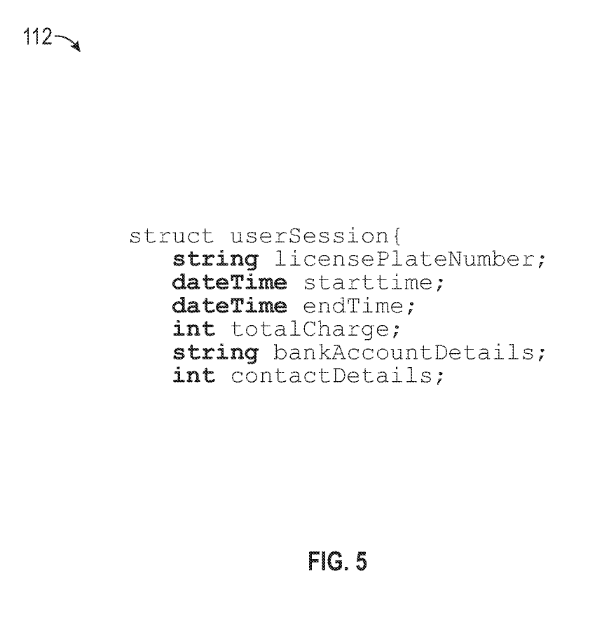

System 50 further includes the use of blockchain nodes. In system 50, each node has three different smart contracts as follows. The provider-consumer smart contract 80 is a smart contract between the service provider 103 and the service consumer 106 and/or 108 (e.g., the user who wants to park). Note that FIG. 6 shows an example of a possible smart contract that can be utilized as the provider-consumer smart contract 80. The enforcer-provider smart contract 78 is a smart contract between the service provider 103 and the enforcing agency 100 (i.e., the stewarding agency which ensures proper laws, rules, and regulations are followed). The data access smart contract 82 is a smart contract that exposes data stored on to the blockchain network 51 to relevant stakeholders.

It should be appreciated that blockchain nodes use and modify data stored in the underlying database using smart contracts such as, for example, one or more of the smart contracts 78, 80, and 82. The database stores two kinds of data i.e., the transaction data itself (details about each transaction like the time, the initiator, the purpose, etc.) and smart contract/stakeholder specific data. This may include data like consumer's bank account details, which will enable auto deduction of the fee once the service is provided.

As the information about the occupancy of all the parking spaces is available in real time, system 50 reads this information using the data access smart contract and can provide customized recommendations to users as to the location where they should park. Such customizations can be provided with respect to the price of the parking space, the distance of the parking space from the final destination, etc. The private/public service providers can have their own analytical engines such as, for example, analytical engines 90 and 92, which read the data of the parking spaces owned by them and obtains insights on demand and occupancy of the parking spaces which can in-turn be used to have dynamic pricing of the parking spaces. This platform can also be used by users to obtain relevant information about parking rates, or by a government to justify a price change, by showing graphs of demand-availability. Additionally, the state of the asset can be tracked in real time or when the asset changes hands depending on the implementation and the source of the damage can be tracked and fined.

In the context of the disclosed example parking use case, the commodity in trade is the parking space. That is, such parking spaces can either be public parking spaces or commercial privately owned parking spaces, depending on which, the service provider will either be the government or private organizations or individual users (e.g., in the disclosed example scenario, we can assume privately owned parking spaces). The service consumers are the citizens (e.g., users) of that particular urban environment or city.

The blockchain network 51 can be initialized with information about, for example, the total number of parking spaces present in the city and their respective locations, the mapping of parking spaces with the parking rate at a particular space and at a particular time of day, a mapping between citizens and their respective vehicles (e.g., license plate numbers), and bank account information associated with a citizen/user, along with the three smart contracts 78, 80, and 82 mentioned previously.

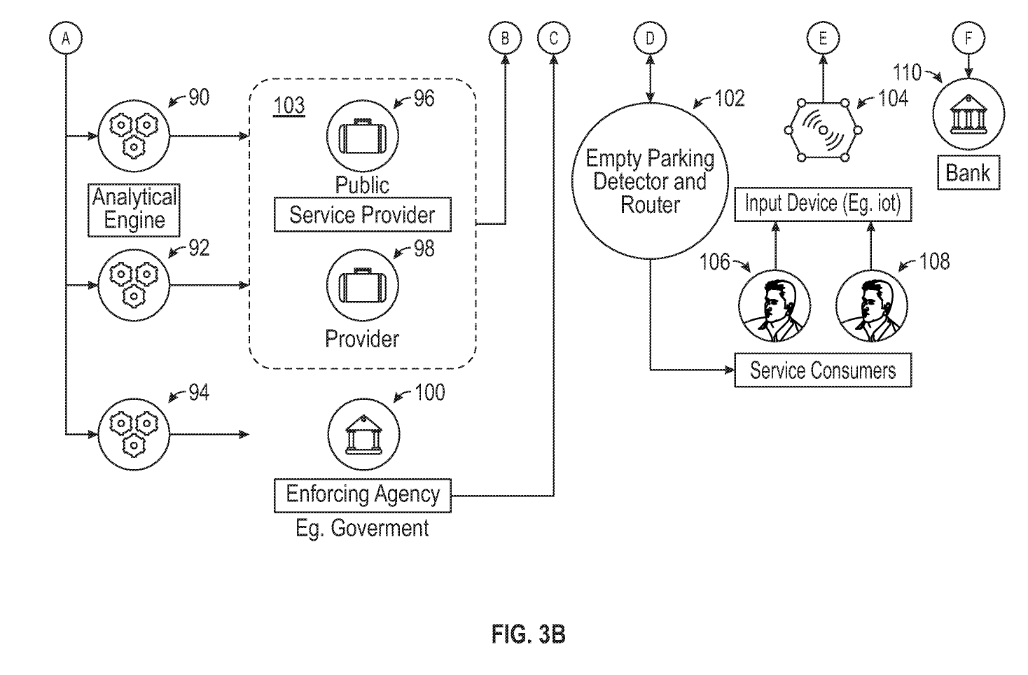

FIG. 4 illustrates a flow diagram depicting logical operational steps of a method 50 for managing an asset dispute, in accordance with an example embodiment. In the example shown in FIG. 4, various sequences of events are possible in the context of different scenarios. The sequence diagram in FIG. 4 describes the communication flow between different stakeholders for the scenario of smart parking with auto detection of start time and auto-deduction of payments. A variety of stakeholders and devices/systems are shown in the method 50 depicted in FIG. 4 including, but not limited to, for example, a service provider 19, a consumer 16 (e.g., individual users), an IoT device 65, a blockchain network 51, a bank 20 or other financial institution or agency, and an enforcer 22.

Note that the term IoT (Internet of Things) as utilized in this document generally refers to the interconnection of uniquely identifiable embedded devices within a network infrastructure. IoT also refers to the devices and machines embedded with electronics and software enabling these devices and machines to exchange data over a network (e.g., the Internet).

As shown in FIG. 4, a smart parking platform can be configured to allow different providers to share/lease their space. As a first step (1), different providers (e.g., commercial agency, individual users, government) register their available parking space in the blockchain network 51. The consumers (i.e., namely citizens) of this service arrive as shown at step (2) at the parking space to station their vehicle. The parking lot is preferably installed with one or more IoT devices as shown at step (3) such as, for example, ALPR (Automatic License Plate Reading) sensors that gather license plate information of the vehicle that has arrived and forwards this information to the blockchain network 51. This action invokes a smart contract defined between the provider and the consumer as indicated at step (4), which records the arrival time of the vehicle in the parking space and initiates the timer. Post timer initiation, a request notification is sent, as indicated at step (5) to the consumer about the parking start time and the corresponding rates of the parking space. Once the citizen accepts the request as shown at step (6), it is translated to a transaction, which is validated, committed, and stored on the blockchain network 51 as shown at step (7). On the other hand, the citizen (consumer) can reject the request notification if he/she notices an incorrect license plate number. In such a scenario (not mentioned in the flow diagram), a manual intervention may be required to input the correct license plate number of the parked vehicle in the system during or after steps 5, 6, and 7.

At regular intervals, the ALPR device (e.g., the IoT device 65) can read the license plate number of the parked vehicle as shown at step 8 in FIG. 4 and sends the license plate information to the blockchain network 51. On receipt of the information, the provider-consumer smart contract 80 can be triggered, which checks whether the received data matches with the existing license plate number information. If the condition is satisfied, no action is taken. This means that the citizen can continue to use the parking space.

If the license plate data does not match or the parking slot is vacated, a function in the provider-consumer smart contract can be executed that is responsible for stopping the timer. This indicates that the citizen (e.g., a user) has vacated the parking space. The smart contract notifies the consumer as shown at step (9) about the availed parking time and its corresponding charges. On a successful notification, the network 51 can invoke the provider-enforcing agency smart contract 78 as indicated at step (10) in FIG. 4, which computes and logs the applicable taxes for the above transaction. It further informs the bank to deduct the corresponding charges as indicated at step (11) in FIG. 4 from the citizen's account. In this process, it advises the bank to transfer the relevant taxes to the enforcing agency 22 as shown at step (12) and the remaining to the provider's account as indicated at step (13). On a successful confirmation about the transfer to its respective recipients, the status of the transaction is changed to complete on the provider-consumer and provider-enforcing agency contracts.

Note that ALPR (Automatic License Plate Recognition) is a technology that utilizes optical character recognition on images to read vehicle registration plates to create location data and other identifying information. ALPR can be used to store the images captured by the cameras as well as the text from the license plate, with some configurable to store a photograph of the driver.

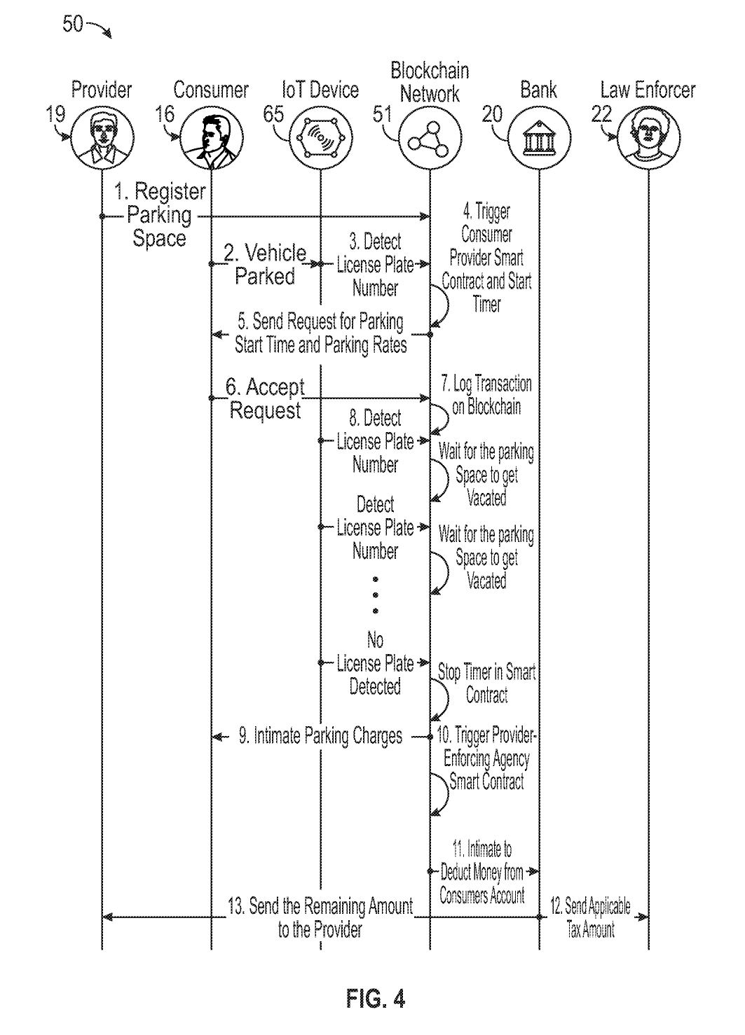

FIG. 5 illustrates an example data structure 112 that can be implemented to save the details of an active consumer using an asset, in accordance with an example embodiment. That is, FIG. 5 shows a data structure 112 capable of being used to save the details of the consumer using the asset at any point in time.

FIG. 6 illustrates an example of a provider-consumer smart contract 114 that can be implemented in accordance with an example embodiment. The provider-consumer smart contract 114 shown in FIG. 6 can be utilized as or with, for example, the provider-consumer smart contract 80 shown in FIG. 3A. The smart contract 114 can utilize the data structure 112 shown in FIG. 5. The example smart contract 114 depicted in FIG. 6 is an example of a provider-consumer smart contract that can be utilized to keep track of the time the consumer has parked and is generally responsible for triggering the provider-enforcer smart contract for relevant tax deduction and for sending an intimation to, for example, the bank 20 to charge a relevant or appropriate amount to the consumer. Other smart contracts can be similarly configured.

Thus, various smart contract operations are shown in FIG. 6. For example, as shown at block 115 in FIG. 6, an operation can be implemented to trigger the aforementioned IoT device (e.g., an ALPR sensor or other device) to read a license plate number of a parked car. As indicated at block 117, an operation can be implemented to start a user session and record the time when the consumer has parked, based on the license plate number. This operation includes fetching the smart contract and account details and intimating the charge and start time with respect to the consumer. As depicted at block 119, an operation can be implemented to detect when the consumer leaves, end the session, compute parking charges, triggering the enforcer-provider smart contract to deduct taxes, intimating the bank to charge the consumer, and intimating the consumer regarding the applied charges. As shown at block 121, an operation can be implemented (similar to the operations shown at block 117) with respect to a new consumer who is now parking. Finally, as depicted at block 123, an operation can be implemented to wait, for example, 60 seconds before checking the license plate again.

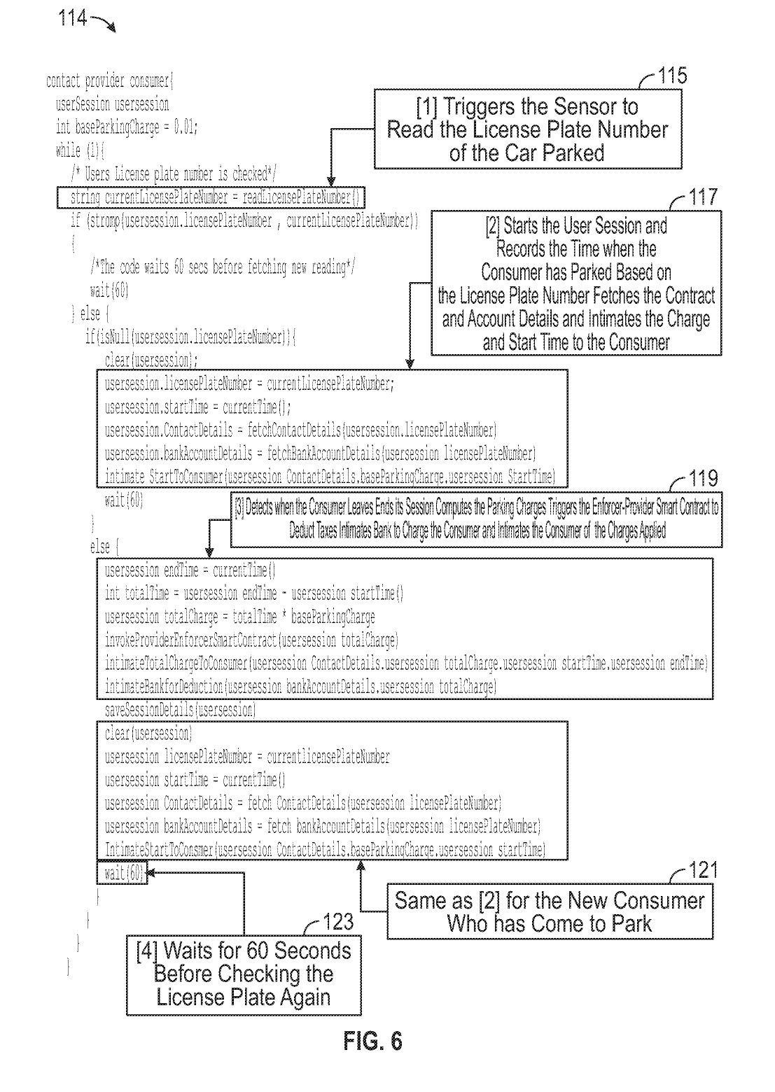

FIG. 7 illustrates a flow diagram depicting logical operational steps of a method 120 for automated free parking space identification and assisted navigation, in accordance with an example embodiment. A variety of steps (1) to (8) of method 120 are shown in FIG. 7. The sequence diagram of method 120 in FIG. 7 describes the communication flow between different actors for the scenario of detecting parking availability, reservation, and routing. The disclosed smart parking platform allows different providers such as provider 19 to share/lease his or her space.

As a first step (1), different providers (e.g., commercial agency, individual users, government, etc.) can register their available parking space in the blockchain network 51. The consumers of this service (citizen) use a mobile app 122 as shown at step (2) in FIG. 7 to determine the availability of parking space in an area. The mobile app 122 forwards the request as shown at step (3) to the blockchain network 51 to discover the available parking spaces. The network executes the data access smart contract 82, for example, as shown at step (4) in FIG. 7, which retrieves the available parking spaces and prices that are spread across different providers from the distributed ledger of the blockchain network 51.

Note that as utilized in this document, the term “app” generally refers to a downloadable self-contained software application. Note that in some instances, the “app” may be implemented not only as a mobile application for a mobile device (e.g., a smartphone, tablet computing device, wearable computing device, laptop computer, etc.), but also as an application accessible through a website on another type of computing device such as a desktop computer.

The response from the smart contract is provided to the consumer 16 as shown at step (5) in FIG. 7. Using the mobile app 122, the citizen or user can select an empty parking space to station the vehicle as shown at step (6). The blockchain network 51 invokes the provider-consumer smart contract to reserve the parking area (7) and it notifies the service provider 19 about the reservation. Further, the smart contract also can inform the consumer 16 about a successful completion of a parking space reservation as shown at step 8. The consumer 16 can avail the reserved parking area to station the vehicle and the rest of the process flow will be the same as mentioned in FIG. 4.

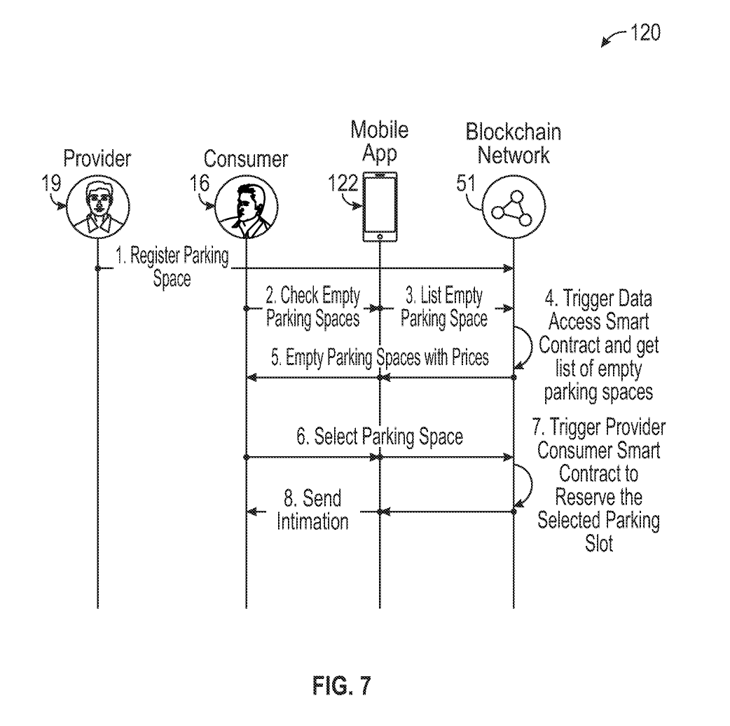

FIG. 8 illustrates a flow diagram depicting logical operational steps of a method 130 for traffic violation detection and fine imposition, in accordance with an example embodiment. Various stakeholders and institutions and devices are shown in the flow diagram of method 130 in FIG. 8. For example, a violator 19 (e.g., a parking space violator) is shown in FIG. 8 along with an IoT device 65 (e.g., an ALPR sensor), the blockchain network 51, a law enforcer 22, and the bank 20. The scenario shown in FIG. 8 demonstrates how blockchain can be used to facilitate compliance in the context of the example parking scenario.

For example, IoT sensors (e.g., ALPR sensors/cameras or other types of sensors/cameras) can be installed at traffic signals, which can detect traffic violations. If a citizen is found to be violating the traffic signals as shown at step (1) in FIG. 8, IoT sensor(s) 65 can capture the license plate information of the violated vehicle and can forward this information to the blockchain network 51 in real time as indicated at step (2) in FIG. 8. At this point the data access smart contract 82 can be triggered fetching the details of the violator 19 as shown at step (3). Further, it can send the violation intimations automatically to the violator 19 and the law enforcing body 22 (e.g., traffic police authority) as indicated at step (4). The specified fine amount can be automatically deducted from the bank account of the violator as shown at step (5).

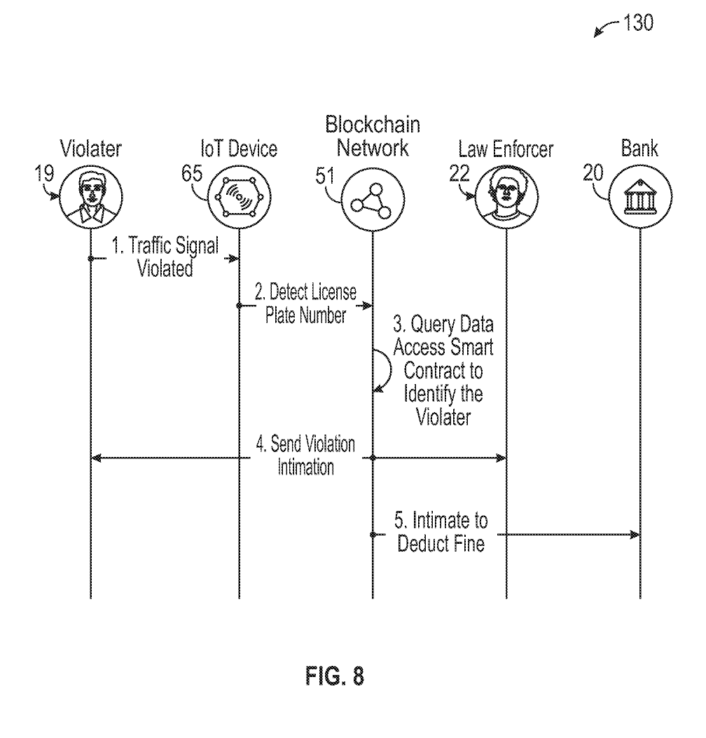

FIG. 9 illustrates a schematic diagram of a system 140 that includes interactions among stakeholders (e.g., enforcer(s) 22, service consumer(s) 16, service provider(s) 19, bank 20, etc.) and the blockchain network 51, in accordance with an example embodiment. System 140 demonstrates that service providers such as service provider 19 can register their assets to be utilized by service consumers such as service consumer 16. In the disclosed parking scenario, parking service providers such as provider 19 can rent/share their parking space to consumers. The law enforcers 22 can further monitor and enforce the law required for the smooth functioning of the ecosystem. Since blockchain has all the data of transactions (e.g., a true copy), blockchain can be utilized as a rich data source supporting multiple analytics engines catering to specific needs of various stakeholders. Further, blockchain can be interfaced with IoT sensors 65 to track the true status of the assets in real time. In a parking scenario, the IoT sensor 65 (e.g., in association with an ALPR detector) can track the occupancy status of a parking slot. Banks (e.g., bank 20) can further enrich the ecosystem to handle payments and its related transactions on behalf of different stakeholders.

It can be appreciated that the disclosed example embodiments are described at least in part herein with reference to flow diagrams, sequence diagrams, schematic diagrams, and/or block diagrams of methods, systems, and computer program products and data structures according to embodiments of the invention. It will be understood that each block or step of the illustrations, and combinations of steps or blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flow diagrams and other diagrams in the figures herein illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 10-11 are shown only as exemplary diagrams of data-processing environments in which example embodiments may be implemented. It should be appreciated that FIGS. 10-11 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 10, some example embodiments may be implemented in the context of a data-processing system/apparatus 400 (i.e., a computing device) that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components.

As illustrated, the various components of data-processing system/apparatus 400 can communicate electronically through a system bus 351 or similar architecture. The system bus 351 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server). Examples of servers are, for example, the servers 32, 34, 36, 40, and 42 shown in FIG. 2.

In some example embodiments, data-processing system/apparatus 400 may be, for example, a standalone desktop computer, a laptop computer, a Smartphone, a pad computing device, and so on, wherein each such device is operably connected to and/or in communication with a client-server based network or other types of networks (e.g., cellular networks, Wi-Fi, etc.).

FIG. 11 illustrates a computer software system/apparatus 450 for directing the operation of the data-processing system/apparatus 400 depicted in FIG. 10. The software application 454 can be stored, for example, in memory 342 shown in FIG. 10. The software system 450 generally includes a kernel or OS (Operating System) 451 and a shell or interface 453 (e.g., a GUI or Graphical User Interface). One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user may supply additional inputs or terminate a session. The software application 454 can include module(s) 452, which can, for example, implement the various steps, instructions, or operations such as those discussed herein. Module 452 may also be composed of a group of modules or sub-modules that implement the various steps, operations, instructions, and methodologies discussed herein. An example of software application 454 is the mobile app 122 discussed previously herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 10-11 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically configured hardware (e.g., because a general purpose computer in effect becomes a special-purpose computer once it is programmed to perform particular functions pursuant to instructions from program software). Note that the data-processing system/apparatus 400 discussed herein may be implemented as special-purpose computer in some example embodiments. Thus, the disclosed system can be implemented in some embodiments as a special-purpose computer and in other embodiments can be implemented in the context of a general-purpose computer.

Based on the foregoing, it can be appreciated that a number of example embodiments are disclosed herein. For example, in one embodiment a blockchain-based system for managing urban assets with an improved ledger data structure (i.e., the Blockchain) can be implemented, which includes a blockchain-based platform that unifies a plurality of stakeholders with respect to at least one asset, wherein the blockchain-based platform is configured to provide the stakeholders with weighted control and ownership of data regarding the at least one asset. The aforementioned blockchain-based platform can be configured to enable tracking of a true state of the at least one asset by maintaining a single version of truth, thereby avoiding disputes with respect to the at least one asset and facilitating an on-demand sharing of the at least one asset.

In another example embodiment, the blockchain-based platform can include an electronic ledger that tracks a plurality of events associated with the at least one asset. In other example embodiments, the at least one asset can comprise a shareable asset. In other example embodiments, the at least one asset can comprise a digital asset and/or a physical asset.

In another example embodiment, at least one IoT device can be utilized for monitoring the at least one asset. In some example embodiments, the at least one IoT device can be an ALPR (Automated License Plate Recognition) sensor and/or a digital camera with image recognition features. In another example embodiment, the at least one IoT devices can monitor an identity of the at least one asset. In some example embodiments, the at least one asset can be a parking space in a parking lot.

In still another example embodiment, a blockchain-based system for managing urban assets with an improved ledger data structure (i.e., the Blockchain) can be implemented, which includes at least one processor and a non-transitory computer-usable medium embodying computer program code. The computer-usable medium is capable of communicating with the at least one processor, and the computer program code includes instructions executable by the at least one processor and configured for: unifying a plurality of stakeholders with respect to at least one asset using a blockchain-based platform, wherein the blockchain-based platform is configured to provide the stakeholders with weighted control and ownership of data regarding the at least one asset; and configuring the blockchain-based platform to enable tracking of a true state of the at least one asset by maintaining a single version of truth, thereby avoiding disputes with respect to the at least one asset and facilitating an on-demand sharing of the at least one asset.

In yet another example embodiment, a blockchain-based method for managing urban assets with an improved ledger data structure (i.e., the Blockchain) can be implemented, which includes the steps, operations, or instructions of: unifying a plurality of stakeholders with respect to at least one asset using a blockchain-based platform, wherein the blockchain-based platform is configured to provide the stakeholders with weighted control and ownership of data regarding the at least one asset; and configuring the blockchain-based platform to enable tracking of a true state of the at least one asset by maintaining a single version of truth, thereby avoiding disputes with respect to the at least one asset and facilitating an on-demand sharing of the at least one asset.

Note that as utilized herein phrases and terms similar to “financial institution” or “bank” may include any entity that offers transaction account services. Although often referred to as a “financial institution,” the financial institution or bank may represent any type of bank, lender, or other type of account issuing institution, such as credit card companies, card sponsoring companies, or third party issuers under contract with financial institutions. It is further noted that other participants may be involved in some phases of the transaction, such as an intermediary settlement institution.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media, which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Although the disclosure includes methods and systems, it is contemplated that these may be embodied in some cases as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A blockchain-based system for managing urban assets with a ledger data structure, said system comprising:
a blockchain-based platform that unifies a plurality of stakeholders with respect to at least one asset, wherein said blockchain-based platform is configured to provide said stakeholders with weighted control and ownership of data regarding said at least one asset; and
wherein said blockchain-based platform is configured to enable tracking of a true state of said at least one asset by maintaining a single version of truth, thereby avoiding disputes with respect to said at least one asset and facilitating an on-demand sharing of said at least one asset.

2. The system of claim 1 wherein said blockchain-based platform comprises an electronic ledger that tracks a plurality of events associated with said at least one asset.

3. The system of claim 1 wherein said at least one asset comprises a shareable asset.

4. The system of claim 1 wherein said at least one asset comprises a digital asset and/or a physical asset.

5. The system of claim 1 further comprising at least one IoT device for monitoring said at least one asset.

6. The system of claim 5 wherein said at least one IoT device comprises an ALPR (Automated License Plate Recognition) sensor and/or a digital camera with image recognition features.

7. The system of claim 1 wherein said at least one IoT devices monitors an identity of said at least one asset.

8. The system of claim 1 wherein said at least one asset comprising a parking space in a parking lot.

9. A blockchain-based system for managing urban assets with a ledger data structure, said system comprising:
at least one processor; and
a non-transitory computer-usable medium embodying computer program code, said computer-usable medium capable of communicating with said at least one processor, said computer program code comprising instructions executable by said at least one processor and configured for:
unifying a plurality of stakeholders with respect to at least one asset using a blockchain-based platform, wherein said blockchain-based platform is configured to provide said stakeholders with weighted control and ownership of data regarding said at least one asset; and
configuring said blockchain-based platform to enable tracking of a true state of said at least one asset by maintaining a single version of truth, thereby avoiding disputes with respect to said at least one asset and facilitating an on-demand sharing of said at least one asset.

10. The system of claim 9 wherein said blockchain-based platform comprises an electronic ledger that tracks a plurality of events associated with said at least one asset.

11. The system of claim 9 wherein said at least one asset comprises a shareable asset.

12. The system of claim 9 wherein said at least one asset comprises a digital asset and/or a physical asset.

13. The system of claim 9 further comprising at least one IoT device for monitoring said at least one asset.

14. The system of claim 13 wherein said at least one IoT device comprises an ALPR (Automated License Plate Recognition) sensor and/or a digital camera with image recognition features.

15. A blockchain-based method for managing urban assets with a ledger data structure, said method comprising:
unifying a plurality of stakeholders with respect to at least one asset using a blockchain-based platform, wherein said blockchain-based platform is configured to provide said stakeholders with weighted control and ownership of data regarding said at least one asset; and
configuring said blockchain-based platform to enable tracking of a true state of said at least one asset by maintaining a single version of truth, thereby avoiding disputes with respect to said at least one asset and facilitating an on-demand sharing of said at least one asset.

16. The method of claim 15 wherein said blockchain-based platform comprises an electronic ledger that tracks a plurality of events associated with said at least one asset.

17. The method of claim 15 wherein said at least one asset comprises a shareable asset.

18. The method of claim 15 wherein said at least one asset comprises a digital asset and/or a physical asset.

19. The method of claim 15 further comprising utilizing at least one IoT device for monitoring said at least one asset, wherein said at least one IoT device comprises an ALPR (Automated License Plate Recognition) sensor and/or a digital camera with image recognition features and wherein said at least one IoT devices monitors an identity of said at least one asset.

20. The method of claim 15 wherein said at least one asset comprising a parking space in a parking lot.
